(19) United States
(12) Patent Application Publication
(10) Pub. No.: US 2021/0118213 A1
(43) Pub. Date: Apr. 22, 2021

(54) SYSTEMS AND METHODS FOR THREE DIMENSIONAL OBJECT SCANNING

(71) Applicant: JJK Holdings, LLC., Santa Clara, CA (US)

(72) Inventor: Yu Ji, Santa Clara, CA (US)

(21) Appl. No.: 16/655,227

(22) Filed: Oct. 17, 2019

(51) Int. Cl. G06T 15/00; H04N 5/247; G06T 17/20; H04N 13/243; H04N 13/25

(52) U.S. Cl. CPC G06T 15/005; H04N 5/247; H04N 13/25; H04N 13/243; G06T 17/20

(57) ABSTRACT

The embodiments describes herein relate generally to capturing a plurality of frames (i.e., image frames) of an object and utilizing those plurality of frames to render a 3D image of the object. The process to render a 3D image consists at least of two phases, a capturing phase and a reconstruction phase. During the capture phase a plurality of frames may be captured of an object and based upon these plurality of frames a 3D model of an object may be rendered by a computational inexpensive algorithm. By utilizing a computational inexpensive algorithm mobile devices may be able to successfully render 3D models of objects.

### BACKGROUND OF THE INVENTION

As mobile devices, such as smart phones, become more popular so does the desire to have those mobile devices replace non-mobile devices, such as televisions and desktop computers. A current dilemma of many mobile devices is the ability to render realistic three dimensional (3D) graphics with the limited processing power of a mobile device. In traditional 3D graphic rendering, computationally intense algorithms may be implemented by graphic processing units (GPUs). Due to the computational expense associated with 3D graphic rendering, these GPUs are often bigger than many mobile devices themselves. For example, a popular mass produced GPU, the 1080Ti by NVidia, plugs into an interface of a computer system and has an approximate height of 4.376 inches and a length of 10.6 inches. Obviously, such a GPU may not fit into many modern mobile devices. As a result, there is a need to provide a system that is capable of rendering high quality 3D graphics without the need of sizable GPU devices.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a second label that distinguishes among the similar components. If only the first reference label is used in the specification, the description can be applicable to any one of the similar components having the same first reference label irrespective of the second reference label.

FIG. 1 depicts an example computer system in accordance with one or more embodiments.

FIG. 2 illustrates an example first camera array configuration in accordance with one or more embodiments.

FIG. 3 depicts an example second camera array configuration in accordance with one or more embodiments.

FIG. 4 illustrates an example image capturing process in accordance with one or more embodiments.

FIG. 5 illustrates an example image reconstruction process in accordance with one or embodiments.

FIG. 6 illustrates a first set of example pattern sequences in accordance with one or more embodiments.

FIG. 7 illustrates a second set of example pattern sequences in accordance with one or more embodiments.

FIG. 8 illustrates a third set of example pattern sequences in accordance with one or more embodiments.

### BRIEF SUMMARY OF THE INVENTION

The embodiments describe herein generally relate to capturing a plurality of frames of an object and utilizing those frames to reconstruct a 3D rendering of the object. In one embodiment, a computer-implemented method is provided, the method comprising receiving, by a computer system, a first indication that an object to be scanned is located atop of a scanning platform. The method further comprising transmitting, by the computer, a first input signal to a display of the scanning platform to instruct the display to output a first pattern. The method further comprising transmitting, by the computer system, a first capture signal to an array of cameras to indicate to one or more cameras of the array of cameras to capture a first image frame of the object. The method further comprising receiving, by the computer system from one or more cameras of the array of cameras, one or more first image frames of the object, wherein each of the one or more first image frames is captured by a different camera of the array of cameras. The method further comprising generating, by the computer, based at least in part on the one or more first image frames, a 3D model of the object.

In one embodiment, the display may be a Liquid Crystal Display (LCD). In one embodiment, the first pattern may be a blank screen. A blank screen may be a screen that is absent of color.

In one embodiment, the method may further comprise transmitting, by the computer, a second input signal to the display of the scanning platform to instruct the display to output a second pattern. In such an embodiment, the method may further comprise transmitting, by the computer system, a second capture signal to an array of cameras to indicate to one or more cameras of the array of cameras to capture a second image frame of the object. The method may further comprise receiving, by the computer system from one or more cameras of the array of cameras, one or more second image frames of the object, wherein each of the one or more second image frames is captured by a different camera of the array of cameras. The method may further comprise generating, by the computer, based at least in part on the one or more second image frames the 3D model of the object.

In one embodiment, the first pattern may be a blank screen and the second pattern may be a checkerboard or chessboard pattern.

In one embodiment, the array of cameras may comprise color cameras and infrared (IR) cameras. In such an instance, the method may further comprise transmitting, by the computer, the first input signal to the color cameras of the array of cameras. In addition, the method may further comprise transmitting, by the computer, the second input signal to the color cameras and the IR cameras of the array of cameras.

In one embodiment, the method may further comprise transmitting, by the computer, a third input signal to the display of the scanning platform to instruct the display to output a third pattern. The first pattern, second pattern, and third pattern may be all distinct patterns. The method may further comprise transmitting, by the computer system, a third capture signal to an array of cameras to indicate to one or more cameras of the array of cameras to capture a third image frame of the object. The method may further comprise receiving, by the computer system from one or more cameras of the array of cameras, one or more third image frames of the object. Each of the one or more third image frames may be captured by a different camera of the array of cameras. The method may further comprise generating, by the computer, based at least in part on the one or more third image frames the 3D model of the object.

A non-transitory storage medium, such as a solid state memory, non-flash memory, read-only memory, and the like may be implemented to store instructions associated with embodiments described herein. Such that when the instructions stored within the non-transitory storage medium are executed by one or more processes cause the one or more processors to perform one or more methods or techniques described herein.

### DETAILED DESCRIPTION OF THE INVENTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration”. Any embodiment or design described herein as “exemplary” is not necessarily to be construed as preferred or advantageous over other embodiments or designs.

The embodiments describes herein relate generally to capturing a plurality of frames (i.e., image frames) of an object and utilizing those plurality of frames to render a 3D image of the object. The process to render a 3D image consists at least of two phases, a capturing phase and a reconstruction phase. During the capture phase, a computer system may detect that an object, to be scanned, is placed on an liquid crystal display (LCD) rotation platform. The computer system may be communicatively coupled to the LCD rotation platform, such that the computer system may control one or more aspects of the LCD rotation platform. For example, the computer system may control the degrees that an LCD rotation platform may rotate or the height of the LCD rotation platform. The LCD platform may comprise an LCD screen/panel, which the object to be scanned may sit atop of. Upon receiving an indication that an object is ready to be scanned, the computer system may cause a set of cameras to capture a first frame of the object. The set of cameras (i.e., camera array) may be arranged in a semi-arch configuration around the object.

During the capturing of the first frame, the LCD panel may be off. In one embodiment, the LCD panel being off may be simply the LCD panel displaying a blank or black screen. This blank or black screen may be referred to as a pattern outputted or displayed by the LCD panel. Then, the computer system may cause the set of cameras to capture a second frame of the object. During the capturing of the second frame, the LCD panel may display a first pattern sequence. The first pattern sequence may comprise a black and white checkerboard pattern. The first pattern (and other patterns) may be displayed on the LCD panel by various means including utilizing an High Definition Multimedia Interface (HDMI) input into the LCD panel. After capturing the second frame, the computer system may cause the set of cameras to capture a third frame of the object. During the capturing of the third frame, the LCD panel may display a second pattern sequence. The second pattern sequence may comprise content rich information. In one embodiment, the second pattern sequence may include natural images. For example, a natural image may be an image of an outdoor scene such as a tree, mountains, and the like. In one embodiment, the second pattern sequence may include special noise patterns containing non-repeating features. These non-repeating features may be in stark contrast to a checker board pattern (e.g., first pattern sequence) as a checker board pattern has repetitive features. The second pattern sequence may include patterns that have different intensities, color, and/or shapes throughout the pattern. For example, an image sequence for the second pattern sequence may include natural images and special noise patterns that contain non-repeating features (unlike checkerboards). These non-repeating features may have different intensities, colors, and shapes (e.g., dots, edges, and/or contours). After capturing the third frame, the computer system may cause the set of cameras to capture a fourth frame of the object. During the capturing of the fourth frame, the LCD panel may display a third pattern sequence. The third pattern sequence may comprise one or more background images. The third pattern sequences may comprise of sequences in different colors such as, red, green, blue, purple, cyan, and yellow with different illuminations (from intensity 0 to 255). For example, the third pattern sequence may comprise a pattern with one hue of blue at a single illumination intensity. In another example, the third pattern sequence may comprise a sequence with two hues of cyan and two hues of yellow wherein each hue has a different illumination. The third pattern sequence may allow the set of cameras to capture the object displaced in different backgrounds, which may aid in producing a rendered 3D object in different backgrounds.

After the fourth frame has been captured by one or more cameras in the set of cameras, the computer system may rotate the LCD rotation platform by sending a signal to a rotation mechanism of the LCD rotation platform that instructs the rotation mechanism to rotate by a set amount of degrees. For example, the rotation mechanism may rotate the LCD rotation platform 20 degrees, 15 degrees, and the like. In one embodiment, the set of cameras may be stationary so in order to fully scan the object the object may be rotated via the LCD rotation platform. Once rotated, the computer system may cause the set of cameras to capture first through fourth frames of an object at the new angle. This process of capturing frames of an object and rotation of the object may be repeated until the object has been rotated a full 360 degrees.

In one embodiment, the rotation of the LCD rotation platform may be confirmed by utilizing two different groups of frames. The first group of frames may comprise of the four frames as described above when the LCD rotation platform has no rotation (0 degrees) or a known initial rotation. A second group of frames may comprise four frames as described above but when the LCD rotation platform has been rotated by some degree. The computer system may affine invariant features from the second group to find a matching frame in the first group. For example, the computer system may utilize an algorithm such as scale-invariant feature transform (SIFT) to detect local features within each frame to determine corresponding features between two frames in different groups of frames. In another example, the computer system may utilize camera data to determine two matching frames. In such an example, a second frame taken by camera 2 at a first rotation may be matched to a second frame taken by camera 2 at the second rotation. Thus, a camera's identification may be utilized to determine matching frames across one or more groups.

Once frames are matched across different groups of frames, the matched pairs may be cascaded into a vector array. In one embodiment, an element in vector array may comprise a pixel coordinate of one of or both of a matched pair of frames. In one embodiment, to aid with vector determination a certain position of the LCD panel (e.g., the top-left corner) may be set as the origin. After the vector array is generated by the computer system, an algorithm such as solvepnp (of Open Computer Vision Library) may be utilized to determine the actual rotation of the LCD rotation platform or the rotation of one or more cameras with respect to the LCD rotation platform. By utilizing an algorithmic approach based on captured frames to confirm the rotation of the LCD rotation platform, a more accurate rotation may be realized than merely relying on an estimated rotation from a rotational mechanism, which may often be erroneous.

All of the captured frames may be stored in data storage associated with the computer system. The computer system may then utilize the plurality of captured frames to reconstruct a 3D rending of the object. In part due to the large volume of frames captured, the reconstruction algorithm/process implemented by the computer system may be relatively computationally inexpensive as compared to other reconstruction algorithms that may utilize less images and perform pixel estimation calculations. In addition, traditional methods such as multi-view stereo, structure from motion, and iterative closet point may all rely on the reflectance of an object to perform 3D reconstruction of that object. Such approaches may not work or be effective for rending 3D objects that are texture less or highly specular. In contrast to the traditional methods, the methods described herein may work well for texture-less or highly specular objects. For example, by feature matching utilizing a Random Sample Consensus (RANSAC) based solvenp with frames containing information from the LCD panel, a more accurate rotation may be determined and any potential issues from a lack of reflectance (or too much reflectance) may be mitigated. For example, the patterns displayed by the LCD panel during image capture may provide an invariant feature between two or more frames with may aid in rotation determination via solvePnP. With accurate rotation calculation, it is possible to fully image an object without the need for object depth estimation. The computer system may be able to blend the captured images together to reconstruct a 3D rendering of an object, which may be computational inexpensive as compared to systems that attempt to estimate object depth values and camera positions from the images captured by actual cameras.

In order to render a 3D image from the captured frames the computer system may first detect an LCD region in an first group of frames. In one embodiment, the LCD region of first group of frames may be captured by specific color cameras of the camera array. In such an embodiment, there may be four cameras that are aligned relatively vertical from the LCD panel, which may constitute as the specific color cameras. It should be noted that one or more frames in the first group of frames could be utilized to detect an LCD region in an image because each frame in the first group of frames has a similar rotation axis and angle. For example, a first group of frames may correspond to images of an object at a first rotation (e.g., 0 degrees), a second group of frames may correspond to images of an object at a second rotation (e.g., 30 degrees), a third group of frames may correspond to images of an object at a third rotation (e.g., 60 degrees), and the like. Thus, the LCD region in a first frame within a first group of frames should be the same as the LCD region in the second frame within the first group of frames. In some instances, it may be beneficial to use multiple frames within a group of frames. For example, due to the pattern sequence corresponding to a particular frame an LCD region may be difficult to decipher by the computer system. In such an example, multiple frames of a frame group may be utilized to identify an LCD region in a group of frames.

Once the LCD region within a first group of frames is detected, the computer system may estimate the rotation axis & angle associated with the first group of frames. The LCD region of a first group of frames may provide one or more invariant features at least due to the pattern(s) displayed by the LCD panel. The rotation axis & angle may be the rotation of the LCD rotation platform or the rotation of the camera array around the LCD rotation platform, or the rotation of a particular camera in the camera array. The estimation of the rotation axis & angle for an a first group of frames may be determined as described above, utilizing a RANSAS based solvepnp algorithm that utilizes previously captured images to determine the rotation axis & angle associated with the first group of frames. The estimation of rotation axis and angle may be determined by one or more frames in the first group of frames. In some instances, it may be beneficial to use multiple frames within a group of frames. For example, due to the pattern sequence corresponding to a particular frame rotation axis and angle estimation may be difficult to decipher by the computer system. In such an example, invariant features may be difficult to decipher in one or more frames within a group of frames and multiple frames of a frame group may be utilized to calculate the estimation of the rotation axis and angle.

In order to render a 3D model from the captured frames, the computer may detect an object region in a first group of frames. In one embodiment, the object region of the first group of frames may be captured by Infrared (IR) cameras of the camera array. Once, the object region is determined, the computer system may reconstruct the 3D geometry associated with the first group of frames. After each rotation of the LCD rotation platform, the computer system computes a depth map based on data obtained from the IR cameras. Next, a depth filter is applied to the depth map. The depth filter may utilize masks that are generated from the first pattern sequence (e.g., checkerboard pattern). The computer system, may then generate a point cloud from the depth map that has been filtered by the depth filter. The generated point cloud may be a point cloud of the filtered depth map. As previously indicated, each rotation (i.e., each group of frames) has a corresponding filtered depth map and point cloud as a data structure to indicate depth data from the filtered depth map. The point cloud may be referred to as the 3D geometry of a group of frames. In some embodiment, the 3D geometry may also include the unfiltered and filtered depth map that correspond to a group of frames.

After the 3D geometry has been determined for each group of frames associated with a scanned object, the computer system may fuse together the multiple 3D geometries to form an overall 3D geometry of the scanned object to generate a mesh of the scanned object. In one embodiment, the computer system may combine all of the 3D geometries by combing all point clouds (e.g., each point cloud associated with each rotation) by cascading all the point clouds. In one embodiment, to eliminate shifting and misaligning between different point clouds, an angle and distance restricted iterative closed point in two order (in serial and inverse) are determined and combined to form a first result. The first result is then input into a Poisson Surface Reconstruction to generate a triangle or polygon mesh from multiple 3D geometries.

After the mesh is generated, the computer system may generate a texture map. The texture map is generated based all the frames captured using color cameras of the camera array. The texture map is then projected onto the mesh of the object. The texture may be a UV texture map, which may be usable by commercial 3D rendering software. In one embodiment, the texture map may be a volume texture map that may support texture-based volume rendering. As a result of applying the texture map to the mesh of the object a rendered 3D object may be viewed.

In one embodiment, light field rendering may be performed by the computer system for rendering for real-time photorealistic rendering for a novel camera (i.e., virtual camera) view. To perform novel camera view rendering, the 4 nearest cameras from the camera array are determined based on the location of the novel camera. The computer system may utilize ray tracing techniques to intersect the scanned object with a ray from the 4 different cameras. The computer system may then determine based on each ray trace the closest camera to the novel camera. In one embodiment, a pixel of the scanned object is verified. In this sense, verification may include a determination that the pixel is not occluded or obstructed in one or more frames associated with the closest camera. If the pixel is occluded then another pixel is selected and the ray tracing process may be repeated to find the closest camera that intersects with the another pixel. Once all pixels are verified they may be rendered to produce a photo realistic image utilizing novel camera view.

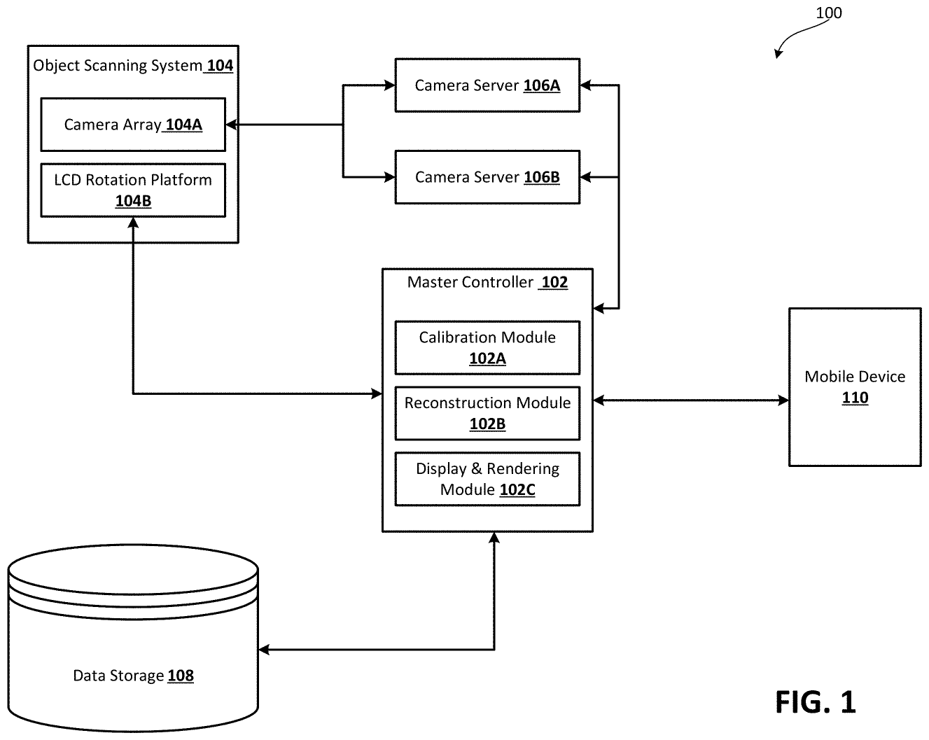

FIG. 1 depicts an computer system 100 in accordance with one or more embodiments. Computer system 100 may comprise, master controller 102, object scanning system 104, camera server 106A, camera server 106B, data storage 108, and mobile device 110. Master controller 102 be comprised of one or more processors and non-volatile memory resources. The processor(s) (e.g., calibration module 102A, reconstruction module 102B, and display & rendering module 102C) may include single or multicore processors. The processor(s) may include general purpose microprocessors such as ones provided by Intel®, AMD®, ARM®, Freescale Semiconductor, Inc., and the like, that operate under the control of software stored in associated memory. An application executed by master controller 102 may be executed by the processor(s). In one embodiment, calibration module 102A may control processes associated with object scanning system 104, such as calibrating camera array 104A and rotating, via rotation mechanism, LCD rotation platform 104B. In one embodiment, reconstruction module 102B may control processes associated with creating a 3D model of a scanned object based upon frames captured by object scanning system 104. Display and rendering module 102C may perform one or more cloud-based processes to remotely render a 3D model on mobile device 110. For example, mobile device 110 may send a request display and rendering module 102C to render for display on the mobile device a first object from a first novel camera. Instead of rending the 3D model itself, display and rending module 102C may perform the processing for rendering the 3D model and then transmit rendering data to mobile device 110 for display. As a result, the processing required to render a 3D model, such as light rendering for a novel camera view, may be handled remotely by master controller 102 instead of locally at mobile device 110.

Object scanning system 104 may be a collection of devices that, under at least partial control of master controller 102, generate one or more frames of an object. The process of taking one or more image frames of an object for the purposes of later reproducing a 3D model of the object may be referred to as “scanning” the object. The generated frames (e.g., image frames) may be later utilized to render a 3D model of an object. Object scanning system 104 may comprise of camera array 104A and LCD rotation platform 104B. Camera array 104A may comprise a plurality of color cameras and IR cameras. In one embodiment, camera array 104A may comprise 10 color cameras and 4 IR cameras. In one embodiment, camera array 104A may be arranged in a semi-arch configuration around the object to be scanned. LCD rotation platform 104B may comprise a plurality of mechanisms to rotate the object to be scanned. LCD rotation platform 104 may comprise an LCD panel which the object to be scanned may be placed upon while the object is being scanned by camera array 104A. In one embodiment, the LCD panel may be attached to another device, such as master controller 102, such that various pattern sequences may be displayed on LCD panel while the object to be scanned is scanned. The patterns displayed via the LCD panel may create invariant aspects across one or more frames. In addition, the patterns displayed via the LCD panel may aid when rendering 3D objects that are texture less or highly specular as opposed to scanning an object with the same background. In addition to the LCD panel, LCD rotation platform 104B may include a rotational motor that is capable of physically rotating LCD rotation platform 104B with respect to camera array 104A. In one embodiment, object scanning system 104 may receive a rotation signal from master controller 102 to rotate LCD rotation platform 104B by a set amount. In response, the rotational motor may be activated and the motor may physically rotate, modify the height, modify an angle, and the like of the LCD panel with respect to the camera array 104. By modifying the LCD rotational platform 104B with respect to camera array 104A several different sets of frames may be acquired for an object.

Camera server 106A and camera server 106B may be one or more computing devices that receive frames taken by one or more cameras in camera array 104A. In one embodiment, camera server 106A may receive frames taken from all color cameras and camera server 106B may receive data taken from all IR cameras. In one embodiment, camera servers 106A and 106B may be included in object scanning system 104. Camera servers 106A and 106B may not only receive frames taken by one or more cameras, but may also receive camera specific information associated with the received frames. For example, camera servers 106A and 106B may receive a focal length associated with a captured frame, a time stamp, position of a camera associated with a captured frame, and the like. As a result, whenever master controller 102 receives one or more captured images it may also receive other data points associated with a captured image.

Data storage 108 may store one or more sets of captured frames of one or more objects that have been scanned. For example, data storage 108 may comprise a plurality of storage location. Each storage location may store captured frames associated with an object. The captured frames may be utilized by master controller 102 (or other devices) to reconstruct a 3D model of a scanned object. Data storage 108 may be implemented by a database, one or more servers, and the like. Data storage 108 may be embodied by a physical storage device such as, a hard disk drive (HDD), solid state drive (SSD), and the like.

Mobile device 110 may be a mobile device that is capable of processing one or more rendering algorithms to render a 3D model of a scanned object based at least in part on captured frames of the scanned object. Mobile device 110 may include various types of computing systems, such as portable handheld devices, general-purpose computers (e.g., personal computers and laptops), workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, tablets, personal digital assistants, and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The mobile device 110 may be capable of executing various different applications such as various Internet-related apps, communication applications (e.g., E-mail applications, short message service (SMS) applications) and may use various communication protocols.

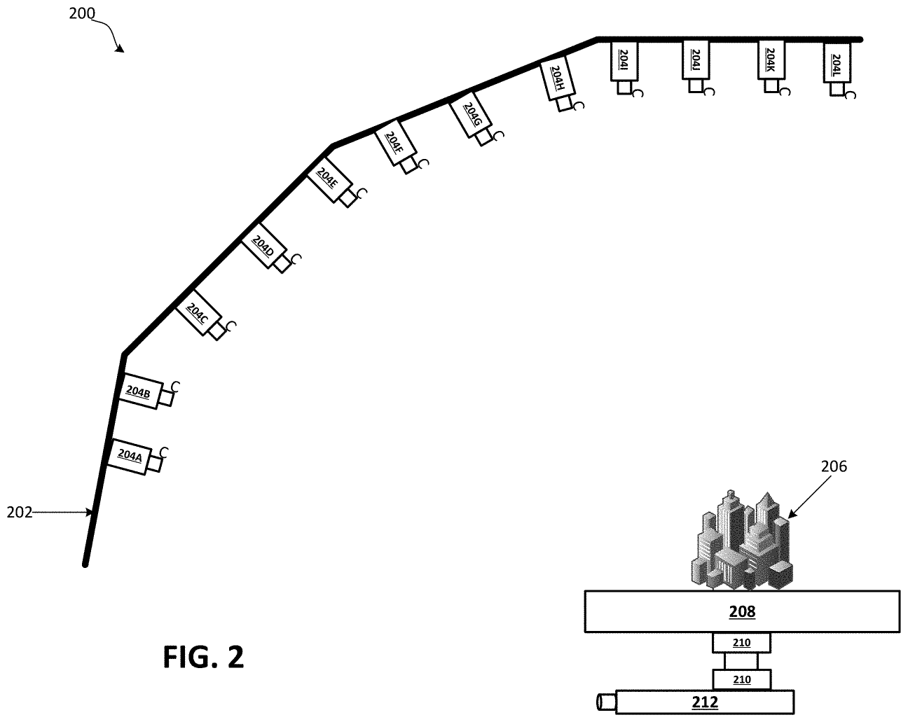

FIG. 2 illustrates camera array configuration 200 in accordance with one or more embodiments. In one embodiment, camera array 104A of FIG. 1 may be configured in camera array configuration 200. Camera array configuration 200 is arranged in a semi-arch configuration around object 206. Cameras within camera array configuration 200 (e.g., cameras 204A-204L) may be held in the semi-arch configuration by beam 202. Beam 202 may be made of any material capable of supporting a plurality of cameras. For example, beam 202 may be made of metal. In one embodiment, when in the semi-arch configuration cameras 204A-204L are each equal distance away from object 206. In other embodiments, other configurations aside from semi-arch may be utilized. Each of camera 204A-204L may correspond to a color camera or an IR camera. In one embodiment, each of camera 204A-204L as shown in FIG. 2 corresponds to a color camera. Each of camera 204A-204L may also be equally spaced from the nearest camera. For example, there may exist a 6 inch distance (or 1 feet distance) between each of camera 204A-204L.

Camera array configuration 200 further comprises LCD panel 208, height adjustment mechanism 210 and rotation mechanism 212. Height adjustment mechanism 210 and rotation mechanism 212 may control the height and rotation of object 206 in relation to cameras 204A-204L. In one embodiment, cameras 204A-204L remain stationary during the scanning of object 206, such that cameras 204A-204L may capture 360 degrees of object 206 without cameras 204A-204L being displaced from an original position. Object 206 may be any object that is to be scanned and eventually have a 3D model rendered. Object 206 may be objects such as a physical model of building, a figurine, a ball, a curio, a candlestick, a handbag, one or more shoes, and the like.

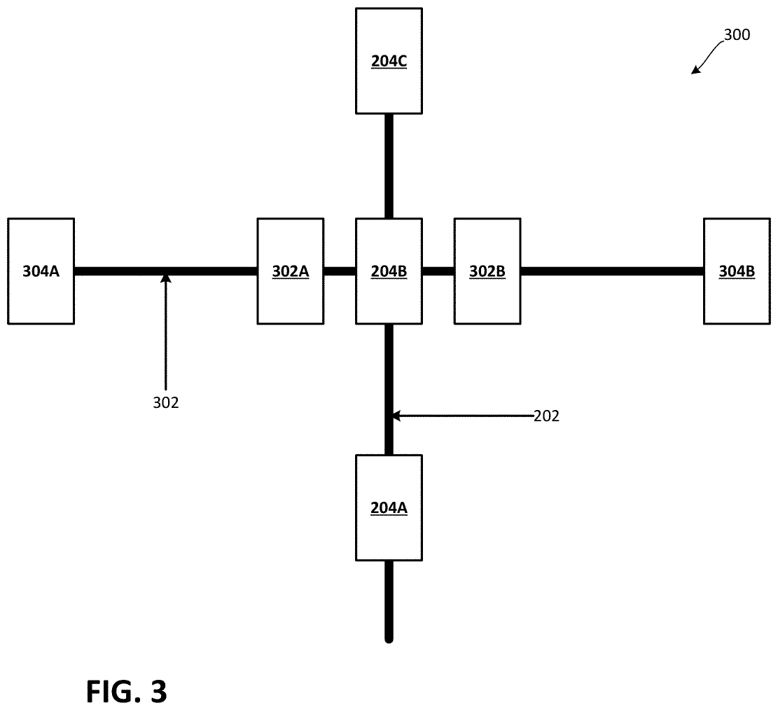

FIG. 3 depicts camera array configuration 300 in accordance with one or more embodiments. In one embodiment, camera array configuration 300 may be a part of camera array configuration 200. Camera array configuration 300 may represent a camera configuration at the base of camera array 104. Camera array configuration 300 comprises color camera 204A, color camera 204B, color camera 204C, IR camera 302A, IR camera 302B, IR projector 304A, and IR projector 304B. Color cameras 204A-204C may be color cameras that capture one or more frames of an object. The frames may be in color or black and white. IR projectors 304A-304B may project IR signals to the object and IR cameras 302A-302B may capture reflected IR signals from IR projects 304A-304B. Based on IR data received from IR cameras 302A-302B, a computer system may generate a depth map of the object and/or a point cloud with depth data of the object. The depth map may indicate distance from a camera to various points in a frame. In one example, darker shades in a depth map may indicate the closer a point is to a camera and lighter shades in the depth map may indicate the further a point is to a camera. A point cloud may be a set of data points in space which measure a large number of points on the external surface of the object. The point cloud of an object may be converted, by a computer system, into a polygon mesh or triangle mesh through the process of surface reconstruction. Surface reconstruction may be achieved by various means, including Delaunay triangulation, alpha shapes, and ball pivoting, which may build a network of triangles over the vertices of the point cloud. Other approaches convert the point cloud into a volumetric distance field and reconstruct the implicit surface so defined through a marching cubes algorithm. Regardless of the methodology utilized, the computer system may utilize the depth map and/or point cloud data to reconstruct the geometry of a scanned object.

Camera array configuration 300 may be structurally supported by beam 202 and beam 302. Beams 202 and 302 may be constructed of any material that is capable of physically supporting the architecture as displayed in FIG. 3. For example, beams 202 and 302 may be constructed of metal.

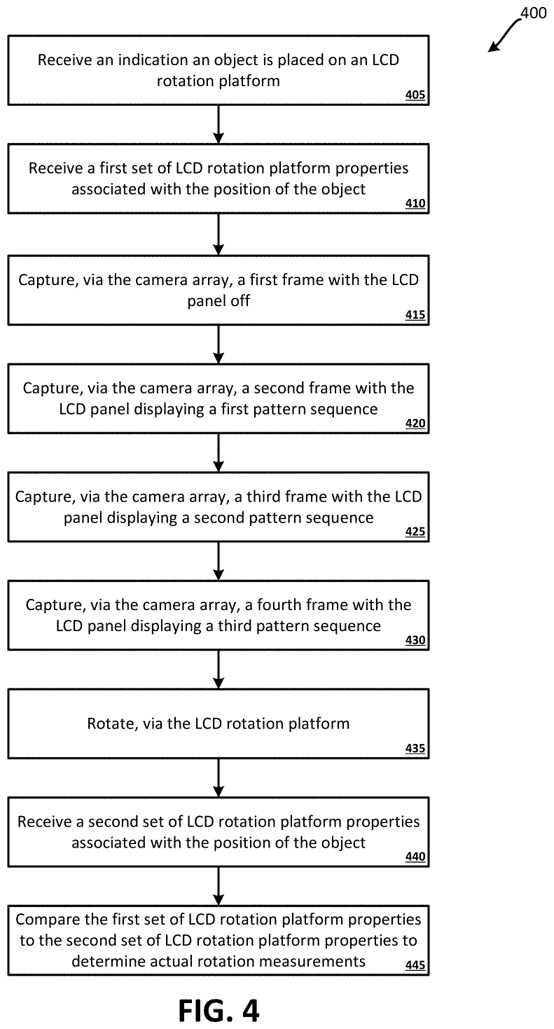

FIG. 4 illustrates an process 400 for image capturing in accordance with one or more embodiments. Process 400 may be performed by one or more parts of a computer system or computer network. For example, computer system 100 of FIG. 1 may perform one or more parts of process 400. At 405, the computer system receives an indication that an object is placed on an LCD rotation platform. The object on the LCD rotation platform may be an object that is to be scanned. The LCD rotation platform may have a sensing mechanism to detect when an object is placed on it. In one embodiment, the sensing mechanism may be a weight detecting mechanism such as a scale or a motion detecting mechanism such as an accelerometer or gyroscope. The LCD rotation platform may be surrounded by a camera array, such that the cameras within the camera array may capture a plurality of frames with respect to the object.

At 410, the computer system receives a first set of LCD rotation platform properties associated with the position of the object. Properties of the LCD rotation platform may include data indicating an initial position of the LCD rotation platform. The LCD rotation platform may be configured to rotate itself 360 degrees. Thus in order to properly determine a complete rotation (e.g., 360 degrees), the computer system may receive an initial rotation of the LCD rotation platform and indicate this rotation as a starting or initial rotation point. Other LCD rotation platform properties may include data indicating the size of an LCD panel within the LCD rotation platform. Depending upon the size of an object to be scanned it may be necessary or beneficial to have larger or smaller LCD panel sizes. Furthermore, the camera array for scanning the object may have to be adjusted based on the size of the LCD panel. For example, the cameras within the camera array may be moved further away from an object when the LCD panel is larger and may be moved closer to the object when the LCD panel is smaller. In either instance, the cameras within the camera array may be equal distance from the object. In another embodiment, the first set of LCD rotation platform properties may be derived from one or more frames taken after the rotation.

At 415, the computer system captures, via the camera array, a first frame with the LCD panel off. The computer system may send a capture signal to the camera array, via one or more camera servers, to capture a first frame. During the capturing of the first frame, the LCD panel is off and the color cameras within the camera array may take a color image of the object. This first image of the object with the LCD panel off may be referred to as a first frame. The first frame is then transmitted from each of the color cameras in the camera array to the computer system for storage and/or subsequent processing.

At 420, the computer system captures, via the camera array, a second frame with the LCD panel displaying a first pattern sequence. The computer system may send an output signal to the LCD panel, via an HDMI input, to display a first pattern sequence. The first pattern sequence may be a checker or chessboard sequence with black and white repetitive boxes. The computer system may send a capture signal to the camera array, via one or more camera servers, to capture a second frame while the LCD panel is displaying the first pattern sequence. This second image of the object with the LCD panel displaying the first pattern sequence may be referred to as a second frame. The second frame is then transmitted from each of the color cameras in the camera array to the computer system for storage and/or subsequent processing.

In one embodiment, at 420, IR cameras within the camera array are utilized to capture geometry data associated with the object. The computer system may send a signal to IR projectors of the camera array, via one or more camera servers, to project IR signals onto the object such that IR cameras within the camera array may capture depth data associated with the object. The captured depth data may be later utilized by the computer system to create a depth map and/or a point cloud associated with the geometry of the object. In one embodiment, depth data is only captured when the LCD panel displays the first pattern sequence.

At 425, the computer system captures, via the camera array, a third frame with the LCD panel displaying a second pattern sequence. The computer system may send an output signal to the LCD panel, via an HDMI input, to display the second pattern sequence. The second pattern sequence may comprise content rich information. In one embodiment, the second pattern sequence may include natural images. For example, a natural image may be an image of an outdoor scene such as a tree, mountains and the like. In one embodiment, the second pattern sequence may include special noise patterns containing non-repeating features. These non-repeating features may be in stark contrast to a checker board pattern (e.g., first pattern sequence) as a checker board pattern has repetitive features. The second pattern sequence may include patterns that have different intensities, color, and/or shapes throughout the pattern. In one embodiment, the second pattern sequence may cycle through multiple patterns based on a time interval. For example, the LCD panel may display at a first time a first natural image such as an ocean then at a second time a second natural image such as a forest, then at a third time a third natural image such as a mountain. A third frame may be taken for each different background. In such an embodiment, the third frame may actually comprise a plurality of frames associated with a single camera. In another embodiment, multiple patterns may be displayed as part of the second pattern sequence. In such an embodiment, ⅓ of the LCD panel may display a mountain, ⅓ of the LCD panel may display an ocean, and ⅓ of the LCD panel may display a forest. Regardless of the pattern methodology utilized for the second pattern sequence one or more frames are captured by the color cameras of the camera array while the LCD panel is displaying one or more parts of a second pattern sequence. The third frame is then transmitted from each of the color cameras in the camera array to the computer system for storage and/or subsequent processing.

At 430, the computer system captures, via the camera array, a fourth frame with the LCD panel displaying a third pattern sequence. The computer system may send an output signal to the LCD panel, via an HDMI input, to display the second third pattern sequence. The third pattern sequence may comprise one or more background images. The third pattern sequences may comprise sequences in different colors such as, red, green, blue, purple, cyan, and yellow with different illuminations (from intensity 0 to 255). For example, the third pattern sequence may comprise a hue of blue at a single intensity, such that the whole or a majority of the LCD panel is displaying a solid blue background. In another example, the third pattern sequence may comprise a sequence with two hues of cyan and two hues of yellow wherein each hue has a different illumination. The third pattern sequence may allow the set of cameras to capture the object displaced in different backgrounds, which may aid in producing a rendered 3D object in different backgrounds. In one embodiment, a fourth frame may be taken for reach different background. In such an embodiment, a fourth frame may actually comprise a plurality of frames associated with a single camera. In another embodiment, multiple patterns may be displayed as part of the third pattern sequence. In such an embodiment, ⅓ of the LCD panel may display a cyan background at a first intensity, ⅓ of the LCD panel may display the cyan background at a second intensity, and ⅓ of the LCD panel may display the cyan background at a third intensity. Regardless of the pattern methodology utilized for the third pattern sequence, one or more frames are captured by the color cameras of the camera array while the LCD panel is displaying one or more parts of a third pattern sequence. The fourth frame is then transmitted from each of the color cameras in the camera array to the computer system for storage and/or subsequent processing.

At 435, the computer system transmits to the LCD rotation platform a rotation signal to instruct the LCD rotation platform to rotate. In one embodiment, the rotational signal may specify an angle and/or axis of rotation. In response to receiving the rotational signal, the LCD rotational platform may, via one or more rotation mechanisms, rotate the object that is being scanned by a set degree. This set degree may be 5 degrees, 10 degrees, 15 degrees and the like. In one embodiment, the set of cameras may be stationary so in order to fully scan the object the object may be rotated via the LCD rotation platform.

At 440, the computer system receives a second set of LCD rotation platform properties associated with the position of the object. Properties of the LCD rotation platform may include data indicating an second position of the LCD rotation platform. The second position of the LCD rotation platform may correspond to a second position of an object as it relates to one or more cameras within the camera array. For example, the second position of the LCD rotation platform may indicate 30 degrees as it relates to a first camera of a camera array. This may indicate to the computer system that object is at a 30 degree angle as it relates to the first camera of the camera array. Other LCD rotation platform properties may include data indicating the size of an LCD panel within the LCD rotation platform, a time stamp, and the like. In another embodiment, the second set of LCD rotation platform properties may be derived from one or more frames taken after the rotation.

At 445, the computer system compares the first set of LCD rotation platform properties to the second set of LCD rotation platform properties to determine an actual rotation. Although the rotation signal transmitted by the computer system to the LCD rotation platform my indicate a degree of rotation, the actual degree that the LCD rotation platform rotates an object with respect to the camera array may be different. By utilizing the first and second set of LCD rotation platform properties the computer system may verify the actual rotation of the object with respect to the camera array. For example, the first set of LCD rotation platform properties may indicate an initial rotation of 20 degrees and the second set of LCD rotation platform properties may indicate a second position of 39 degrees with respect to the same camera within the camera array. On the other hand, the rotation signal may have indicated to the LCD rotation platform to rotate 20 degrees. As a result, the actual rotation may be only 19 degrees, but the commanded rotation may be 20 degrees. This may leave approximately 1% error in determining a captured portion of the object to be scanned. If such an error was repeated, for example, 5 times, then it is likely that 5% of an object may not be scanned, which may result in increased pixel approximation when a 3D model of the object is to be generated and rendered.

In another embodiment, at 445, the computer may determine an actual rotation of the LCD rotation platform based on captured frames at different rotations. A first frame may comprise a frame associated with a first camera with a first LCD panel pattern at an initial time. A second frame may comprise a frame associated with the first camera with a first LCD panel pattern at a second time. The first frame and second frame may be matched pair of frames based at least in part on the fact that they are frames taken from the same camera with the same LCD panel at two different rotations. The matched pairs may be cascaded into a vector array. In one embodiment, an element in vector array may comprise a pixel coordinate of one of or both of a matched pair of frames. After the vector array is generated by the computer system, an algorithm such as solvepnp may be utilized to determine the actual rotation of the LCD rotation platform or the rotation of one or more cameras with respect to the LCD rotation platform. By utilizing an algorithmic approach based on captured frames to confirm the rotation of the LCD rotation platform, a more accurate rotation may be realized than merely relying on an estimated rotation from a rotational mechanism, which may often be erroneous.

Regardless of the methodology utilized to determine an erroneous rotation, if an erroneous rotation is discovered, the computer system may indicate the error to the LCD rotation platform and the LCD rotation platform may take corrective action to adjust the rotation accordingly. For example, the rotation signal at 435 indicates a rotation of 20 degrees, but it is later determined at 445 that the actual rotation is 19 degrees then the computer system may transmit a second rotation signal to the LCD rotation platform to rotate 1 degree or other corresponding amount. At this point a new second set of LCD rotation platform properties may be taken to determine if, after receiving the second rotation signal if the LCD rotation platform has actually rotated by 20 degrees. If the LCD rotation platform is still not in the proper position, then this process may be repeated until it is determined that the LCD rotation platform is in the proper position for subsequent frame capturing by cameras of the camera array.

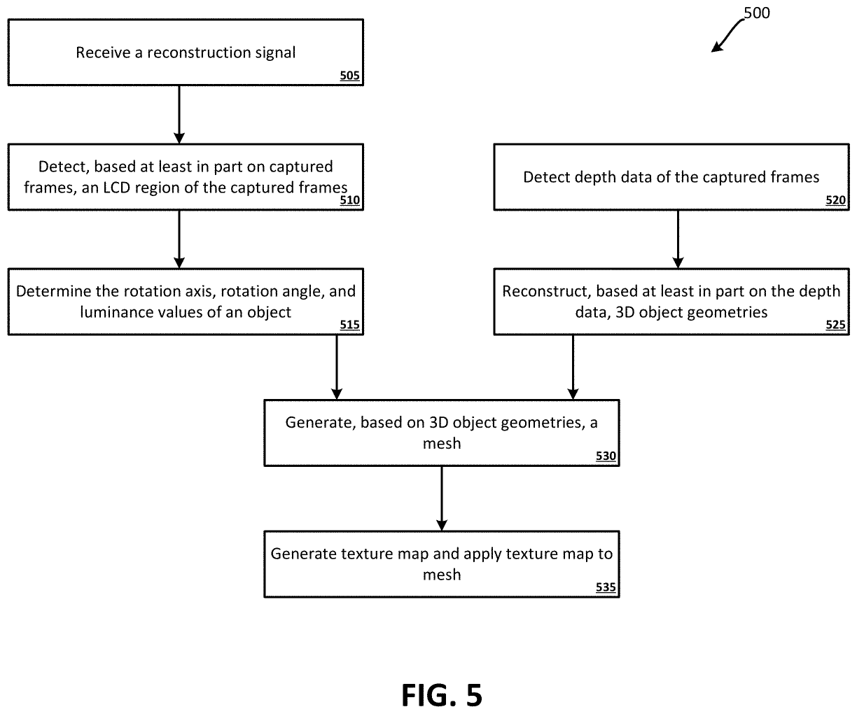

FIG. 5 illustrates process 500 for reconstructing a 3D model of a scanned object in accordance with one or embodiments. Process 500 may be performed by one or more parts of a computer system or computer network. For example, computer system 100 of FIG. 1 may perform one or more parts of process 500. At 505, the computer system receives a reconstruction signal. The reconstruction signal may be sent from a remote mobile device or may be triggered by capturing a last group of frames of a scanned object. The reconstruction signal may indicate to the computer system to reconstruct a 3D model of a scanned object from one or more views. One or more views may correspond to an actual recorded camera view or a novel camera view. The reconstruction signal may identify one or more groups of frames associated with a scanned object. For example, the reconstruction signal may indicate “ball 7-7-2019” which may indicate to computer to retrieve data from a particular location. In such an example, a file path may be C:/2019/July/07/ball. Other data may be utilized to indicate where groups of frames for the recreation of a 3D model of a particular object are located. In one embodiment, each scanned object has a different storage location for its corresponding group of frames. Once the computer system receives the reconstruction signal and locates, within storage, the captured frames associated with the reconstruction signal process 500 moves to 510.

At 510, the computer system detects, based at least in part on captured frames, an LCD region in the captured frames. In one embodiment, the computer system may determine the LCD region in the captured frames from frames captured by specific color cameras of the camera array. In such an embodiment, there may be four cameras (out of ten color cameras) that are aligned relatively vertical from the LCD panel which may constitute as the specific color cameras. The color cameras which capture the LCD region may be defined prior to any frames being captured. For example, the cameras which capture the LCD region may be determined prior to process 400 as described in FIG. 4. In one embodiment, a purpose of determining the LCD region may be to exclude wrong matching from object reflection and also for acceleration purposes. For example, by utilizing the LCD region, feature matching (e.g., finding common features) between one or more images may be quickly determined, which may save processing time as opposed to trying to find common features across within a non LCD-region, which may not include displayed patterns.

At 515, the computer system determines the rotation of the LCD rotation platform with respect to different groups of the captured frames. Within storage there may be different groups of frames within the captured frames. Each group of frames may correspond to frames captured at each rotation. For example, a first group of frames may be frames captured by any camera in the camera array at a first rotation, a second group of frames may be frames captured by any camera in the camera array at a second rotation, a third group of frames may be frames captured by any camera in the camera array at a third rotation, and so forth. The computer may determine a rotation associated with each of the group of frames may various means. These means may be those as previously described in the disclosure.

At 520, the computer system detects depth data of the captured frames. The computer system may detect an object region based upon the type of camera utilized to capture a frame. For example, there may be four IR cameras that may capture depth data associated with a scanned object. The IR cameras may capture depth data at each rotation. For example, the IR cameras may capture first depth data at a first rotation, second depth data at a second rotation, and third depth data at a third rotation. By identifying which data within storage is associated with one or more IR cameras, the computer system may determine depth data associated with an object region at each rotation.

At 525, the computer system reconstructs, based at least in part on the depth data, 3D object geometries. For each rotation, the computer system may reconstruct a 3D geometry of a scanned object. The 3D geometry may be determined by various means, including utilizing depth maps and/or point clouds. For example, the computer system may determine a depth map of a scanned object at a first rotation, a depth map of a scanned object at a second rotation, and so forth. In such an example, each depth map at each rotation may be a 3D geometry.

At 530, the computer system generates, based on the 3D geometries, a mesh. After the 3D geometries have been determined, the computer system may fuse together the multiple 3D geometries to form an overall 3D geometry to generate a mesh. In one embodiment, the computer system may combine all of the 3D geometries by combing all point clouds by cascading all the point clouds. In one embodiment, to eliminate shifting and misaligning between different point clouds, an angle and distance restricted iterative closed point in two order (in serial and inverse) are determined and combined to form a first result. The first result is then input into a Poisson Surface Reconstruction to generate a triangle or polygon mesh from multiple 3D geometries.

At 535, the computer system generates a texture map and applies the texture map to the mesh. After the mesh is generated, the computer system may generate a texture map. The texture map is generated based all the captured frames that are associated with color cameras of the camera array. The texture map is then projected onto the mesh. In one embodiment, the texture map may be a volume texture map that may support texture-based volume rendering. As a result, of applying the texture map to the mesh a 3D model of a scanned object may be created. The 3D model may then be rendered for viewing on a display. Process 500 may be a relatively computational inexpensive process as compared to other rendering processes due in part to the voluminous amount of object data captured by, for example, process 400. The frames captured for a particular object include at least four frames for each rotation. By capturing so much data of an object (e.g., object with different LCD panel backgrounds), the processing power needed for reconstruction of a 3D model of scanned object is relatively low and thus can be performed on mobile devices and other devices without expensive GPU configurations.

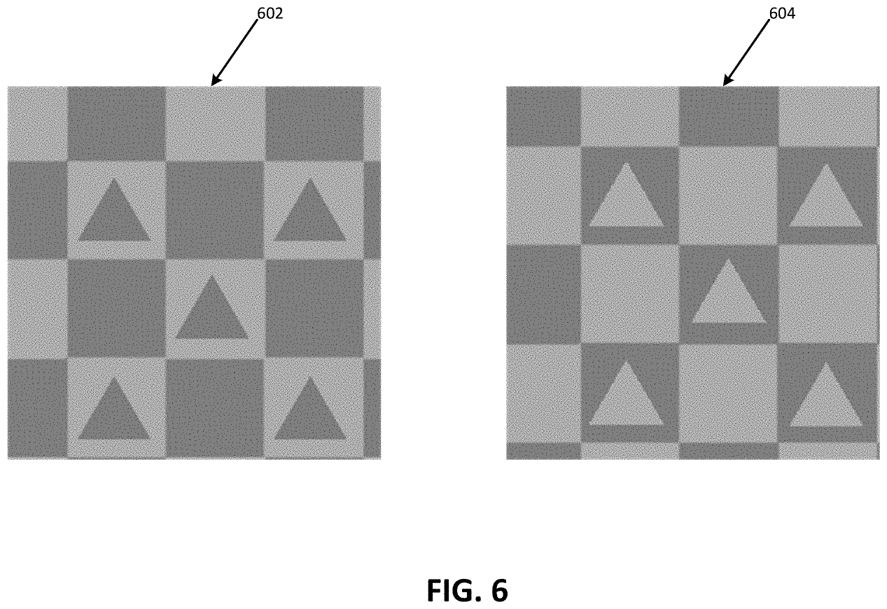

FIG. 6 illustrates a first set of exemplary pattern sequences in accordance with one or more embodiments. FIG. 6 comprises pattern 602 and pattern 604. Pattern 602 and pattern 604 may be an example of a checkboard or chessboard pattern sequence. In one embodiment, pattern 602 and/or pattern 604 may be implemented with color or by grayscale.

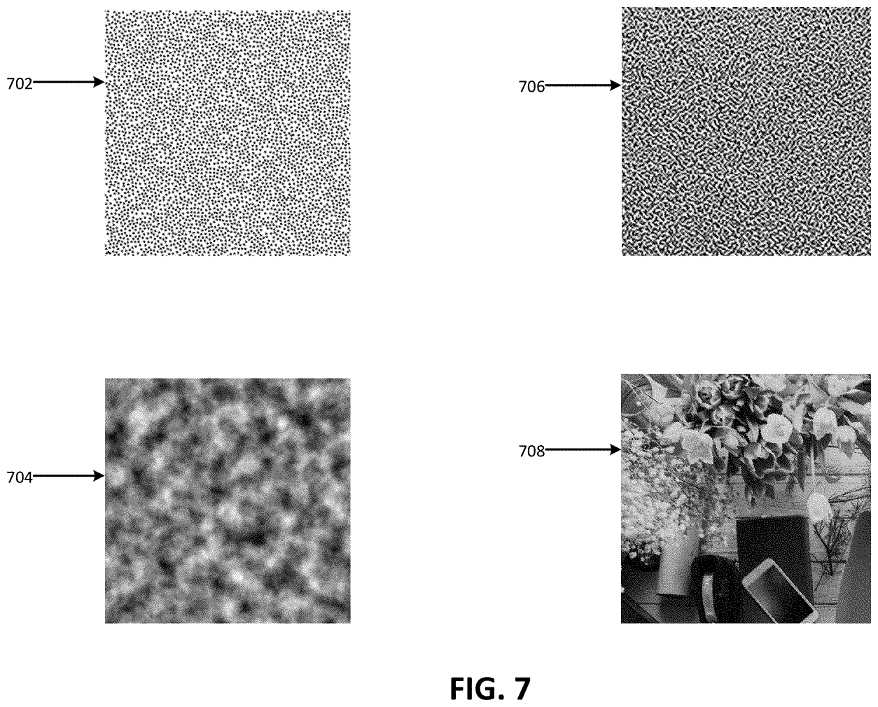

FIG. 7 illustrates a second set of exemplary pattern sequences in accordance with one or more embodiments. FIG. 7 comprises patterns 702-708. Patterns 702-706 illustrate exemplary special noise patterns. Pattern 708 illustrates an exemplary natural image. Pattern 708 comprises one or more natural elements such as flowers. In one embodiment patterns 702-708 may be implemented with color or by grayscale.

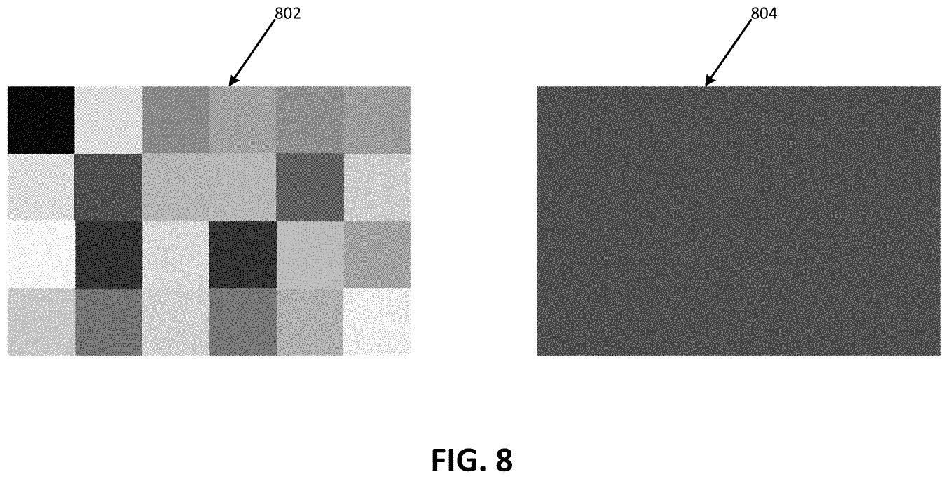

FIG. 8 illustrates a third set of exemplary pattern sequences in accordance with one or more embodiments. FIG. 8 comprises patterns 802-804. Patterns 802-804 may be an example of background images. Pattern 802 may comprise a plurality of squares each with different color. For example, pattern 802 may comprise a black square, red square, orange square, blue square, a green square of a first hue, a green square of a second hue, a yellow square, a cyan square, a gray square of a first, second, and third hue, and the like. Pattern 804 may comprise a single color such as a first hue of red.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in any order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

1. A computer-implemented method comprising:
receiving, by a computer system, a first indication that an object to be scanned is located atop of a scanning platform;
transmitting, by the computer, a first input signal to a display of the scanning platform to instruct the display to output a first pattern;
transmitting, by the computer system, a first capture signal to an array of cameras to indicate to one or more cameras of the array of cameras to capture a first image frame of the object;
receiving, by the computer system from one or more cameras of the array of cameras, one or more first image frames of the object, wherein each of the one or more first image frames is captured by a different camera of the array of cameras; and
generating, by the computer, based at least in part on the one or more first image frames, a 3D model of the object.

2. The computer-implemented method of claim 1, wherein the display is a Liquid Crystal Display

3. The computer-implemented method of claim 1, wherein the first pattern is a blank screen.

4. The computer-implemented method of claim 1, further comprising:
transmitting, by the computer, a second input signal to the display of the scanning platform to instruct the display to output a second pattern;
transmitting, by the computer system, a second capture signal to an array of cameras to indicate to one or more cameras of the array of cameras to capture a second image frame of the object;
receiving, by the computer system from one or more cameras of the array of cameras, one or more second image frames of the object, wherein each of the one or more second image frames is captured by a different camera of the array of cameras; and
generating, by the computer, based at least in part on the one or more second image frames the 3D model of the object.

5. The computer-implemented method of claim 4, wherein the first pattern is a blank screen and the second pattern is a checkerboard or chessboard pattern.

6. The computer-implemented method of claim 5, wherein the array of cameras comprises color cameras and infrared (IR) cameras, the method further comprising:
transmitting, by the computer, the first input signal to the color cameras of the array of cameras; and
transmitting, by the computer, the second input signal to the color cameras and the IR cameras of the array of cameras.

7. The computer-implemented method of claim 4, further comprising:
transmitting, by the computer, a third input signal to the display of the scanning platform to instruct the display to output a third pattern, wherein the first pattern, second pattern, and third pattern are all distinct patterns;
transmitting, by the computer system, a third capture signal to an array of cameras to indicate to one or more cameras of the array of cameras to capture a third image frame of the object;
receiving, by the computer system from one or more cameras of the array of cameras, one or more third image frames of the object, wherein each of the one or more third image frames is captured by a different camera of the array of cameras; and
generating, by the computer, based at least in part on the one or more third image frames the 3D model of the object.

8. A non-transitory computer-readable storage medium having stored thereon instructions, the instructions comprising:
receiving a first indication that an object to be scanned is located atop of a scanning platform;
transmitting a first input signal to a display of the scanning platform to instruct the display to output a first pattern;
transmitting a first capture signal to an array of cameras to indicate to one or more cameras of the array of cameras to capture a first image frame of the object;
receiving, from one or more cameras of the array of cameras, one or more first image frames of the object, wherein each of the one or more first image frames is captured by a different camera of the array of cameras; and
generating, based at least in part on the one or more first image frames, a 3D model of the object.

9. The non-transitory computer-readable storage medium of claim 8, wherein the display is a Liquid Crystal Display

10. The non-transitory computer-readable storage medium of claim 8, wherein the first pattern is a blank screen.

11. The non-transitory computer-readable storage medium of claim 8, the instructions further comprising:
transmitting a second input signal to the display of the scanning platform to instruct the display to output a second pattern;
transmitting a second capture signal to an array of cameras to indicate to one or more cameras of the array of cameras to capture a second image frame of the object;
receiving, from one or more cameras of the array of cameras, one or more second image frames of the object, wherein each of the one or more second image frames is captured by a different camera of the array of cameras; and
generating, based at least in part on the one or more second image frames the 3D model of the object.

12. The non-transitory computer-readable storage medium of claim 11, wherein the first pattern is a blank screen and the second pattern is a checkerboard or chessboard pattern.

13. The non-transitory computer-readable storage medium of claim 12, wherein the array of cameras comprises color cameras and infrared (IR) cameras, the instructions further comprising:
transmitting the first input signal to the color cameras of the array of cameras; and
transmitting the second input signal to the color cameras and the IR cameras of the array of cameras.

14. The non-transitory computer-readable storage medium of claim 11, the instructions further comprising:
transmitting a third input signal to the display of the scanning platform to instruct the display to output a third pattern, wherein the first pattern, second pattern, and third pattern are all distinct patterns;
transmitting a third capture signal to an array of cameras to indicate to one or more cameras of the array of cameras to capture a third image frame of the object;
receiving, from one or more cameras of the array of cameras, one or more third image frames of the object, wherein each of the one or more third image frames is captured by a different camera of the array of cameras; and
generating, based at least in part on the one or more third image frames the 3D model of the object.

15. A system for detecting policy violations for an organization, comprising:
one or more processors; and
a memory coupled with the one or more processors, the memory configured to store instructions that when executed by the one or more processors cause the one or more processors to:
receive a first indication that an object to be scanned is located atop of a scanning platform;
transmit a first input signal to a display of the scanning platform to instruct the display to output a first pattern;
transmit a first capture signal to an array of cameras to indicate to one or more cameras of the array of cameras to capture a first image frame of the object;
receive, from one or more cameras of the array of cameras, one or more first image frames of the object, wherein each of the one or more first image frames is captured by a different camera of the array of cameras; and
generate, based at least in part on the one or more first image frames, a 3D model of the object.

16. The system of claim 15, wherein the display is a Liquid Crystal Display

17. The system of claim 15, wherein the first pattern is a blank screen.

18. The system of claim 15, wherein the instructions that when executed by the one or more processors further cause the one or more processors to:
transmit a second input signal to the display of the scanning platform to instruct the display to output a second pattern;
transmit a second capture signal to an array of cameras to indicate to one or more cameras of the array of cameras to capture a second image frame of the object;
receive, from one or more cameras of the array of cameras, one or more second image frames of the object, wherein each of the one or more second image frames is captured by a different camera of the array of cameras; and
generate, based at least in part on the one or more second image frames, the 3D model of the object.

19. The system of claim 18, wherein the first pattern is a blank screen and the second pattern is a checkerboard or chessboard pattern.

20. The system of claim 19, wherein the array of cameras comprises color cameras and infrared (IR) cameras, wherein the instructions that when executed by the one or more processors further cause the one or more processors to:
transmit the first input signal to the color cameras of the array of cameras; and
transmit the second input signal to the color cameras and the IR cameras of the array of cameras.
